(19) United States
(12) Patent Application Publication
(10) Pub. No.: US 2005/0181186 A1
(43) Pub. Date: Aug. 18, 2005

(54) Textured paint effect

(76) Inventor: Andrew Sean Marshall, Leicestershire (GB)

Correspondence Address: Clifford Kraft, 320 Robin Hill Dr., Naperville, IL, 60540, US

(21) Appl. No.: 11/057,061

(22) Filed: Feb. 11, 2005

(30) Foreign Application Priority Data
Feb. 12, 2004 (GB) 0403079.7

(51) Int. Cl. B32B 3/00

(52) U.S. Cl. 428/195.1

(57) ABSTRACT

A surface such as a body panel of a vehicle is given a decorative effect by coating it with lacquer, applying a heat-stamp light-reactive metallic foil to the lacquer before it sets, stripping off the backing of the foil and applying pressure to the foil, the whole operation being carried out at room temperature. Solid colours can be applied over the foil and can be unevenly distributed by rag rolling. A final layer of lacquer is then applied.

This application is related to and claim priority from British application 0403079.7 filed Feb. 12, 2004.

This invention relates to paint effect finishes which may be used for the automotive paint (spray) industry or any type of product decoration.

Paint finishes, especially in industrial processes such as spray-painting, are well known. They are not difficult to achieve and thus are frequently done mechanically. They are also durable and are used extensively in the automotive industry. The drawback is that they are visually uninteresting, being limited to one colour or to one colour sprayed over or mixed with another to achieve a range of colours. Metallic-effect paints can be incorporated to create a reflective surface but the effect thus achieved creates no depth or texture.

Heat-stamp light-reactive foils are well known in the stationery, art and graphics design and printing industries. These are reflective metal or metal-effect foils, generally but not exclusively chrome-based transferred printing foils, which comprise a durable backing, a visual effect such as a pattern and often an iridescent effect due to their light-reactive qualities. They are frequently used in holographic technology. The foils are applied to a surface and then heat and pressure are applied. The backing of the foil is lifted off to reveal that the visual effect has been transferred to the surface. The drawback of this technology is that it requires a temperature of around 90-120 degrees Celsius and is thus not suitable for a variety of industrial applications.

A principal object of the present invention is to combine heat-stamp light-reactive foils with industrial processes such as the one hereinbefore described to permit visual effects such as iridescence to be applied to a new range of surfaces including, but not limited to, the bodywork of an automobile.

According to the present invention there is provided a method of providing a surface with a decorative effect using a foil which provides the effect and which has a backing, the method comprising coating the surface with an adhesive substance and before said substance has fully dried or cured applying the foil to the surface, stripping the backing from the foil and applying pressure to the foil, the entire operation being carried out at room temperature.

The adhesive substance is preferably a chemically hardening lacquer which is sprayed onto said surface.

Preferably the foil is a hot-stamping, light-reactive metallic foil.

Preferably pressure is applied by the use of a roller.

The method may comprise the subsequent steps of spraying the foil with a metal primer, an enamel or a cellulose lacquer, allowing to dry and then spraying one or more solid colours over the dried primer.

The solid colour(s) may be distributed non-uniformly by rag-rolling before the colour(s) is/are dry.

After rag-rolling the surface may be allowed to dry and a translucent colour may be sprayed over the whole.

The method may also comprise subsequently spraying with one or more coats of lacquer to finish.

A preferred embodiment of the invention will now be described by way of non-limitative example:

A ready-prepared panel of the bodywork of an automotive vehicle was sprayed with a 2-pack, chemically hardening lacquer. Before the lacquer dried or set a hot-stamping light-reactive chrome foil having a decorative iridescent effect and a backing was stretched over the lacquered surface. The backing was peeled off leaving a light-reactive foil relief bonded to the paint surface by the lacquer. A rubber roller was used to flatten the foil relief, ensuring that all foil residues were bonded to the lacquer. The whole treated surface was sprayed with a transparent metal primer and left to flash off. A solid light-reactive colour was now sprayed over the primer and while still wet subjected to rag rolling. After leaving the solid colour to flash off a light-reactive translucent colour was sprayed over the whole surface after which one or more coats of clear lacquer were applied over the whole treated surface.

1. A method of providing a surface with a decorative effect using a foil which provides the effect and which has a backing, the method comprising coating the surface with an adhesive substance and before said substance has fully dried or cured applying the foil to the surface, stripping the backing from the foil and applying pressure to the foil, the entire operation being carried out at room temperature.

2. The method as claimed in claim 1, wherein the adhesive substance is a chemically hardening lacquer which is sprayed onto said surface.

3. The method as claimed in claim 1, wherein the foil is a hot-stamping light-reactive metallic foil.

4. The method as claimed in claim 1, wherein pressure is applied by use of a roller.

5. The method as claimed in claim 1, comprising the subsequent steps of spraying the foil with a metal primer, and enamel or a cellulose lacquer, allowing to dry, and then spraying one or more solid colors over the dried primer.

6. The method as claimed in claim 5, wherein the sold color(s) is/are distributed non-uniformly by rag-rolling before the color(s) is/are dry.

7. The method as claimed in claim 6, wherein after rag-rolling, the surface is allowed to dry and a translucent color is sprayed over the whole.

8. The method as claimed in claim 6 further comprising subsequently spraying with one or more coats of lacquer to finish.

9. The method as claimed in claim 7 further comprising subsequently spraying with one or more coats of lacquer to finish.

10. An article of manufacture with at least one surface upon which it is desired to provide a decorative effect comprising:
an adhesive layer in contact with said surface;
a foil layer in contact with said adhesive layer, said foil layer being pressed onto said adhesive layer before said adhesive layer has dried or cured;
a finish layer of metal primer under enamel or cellulose lacquer;
a color layer on said enamel or lacquer finish layer.

11. The article of manufacture claimed in claim 10 wherein said color layer is distributed non-uniformly by rag-rolling.
